(19) United States
(12) Patent Application Publication
(10) Pub. No.: US 2007/0141927 A1
(43) Pub. Date: Jun. 21, 2007

(54) Method and system for exterior protection of an aircraft

(76) Inventor: Arlene M. Brown, Normandy Park, WA (US)

Correspondence Address: KLEIN, O'NEILL & SINGH, LLP, 43 CORPORATE PARK, SUITE 204, IRVINE, CA, 92606, US

(21) Appl. No.: 11/314,475

(22) Filed: Dec. 21, 2005

(51) Int. Cl. D03D 15/00; D03D 9/00; B32B 27/12

(52) U.S. Cl. 442/6; 442/20; 442/38

(57) ABSTRACT

A method of forming an exterior surface protective structure (12) for an aircraft (10) includes providing a surfacer (26) having a carrier on a metal mesh material (24) and an isolator (22) with resin in the surfacer and the isolator filling holes in the metal mesh to form a surface that may be covered with finishes (28), such as spray applied surfacers, primer(s) and a paint to provide a more robust structure that resists corrosion and prevents substrate microcracking, while providing rain erosion resistance, environmental durability, structural performance, and lightning protection in a lighter weight and less costly material.

### BACKGROUND OF THE INVENTION

1. Field of the Invention

This invention relates generally to material protective systems, and more particularly to an improved method of forming an exterior surface and an improved system for exterior coatings on composites and the like to provide more environmentally friendly, durable and lightweight protection against corrosion and lightning.

2. Description of Related Art

A common method for protection of exterior surfaces of materials, such as composite materials used on aircraft against lightning strikes, is to metallize the outer surface by co-curing the surface of the composite material with metal wires, woven fabric or expanded metal foil to dissipate the electrical energy. However, some of the present lightning protective structures, although feasible for use on spacecraft and some aircraft, are not feasible for use on high use commercial aircraft. This is due to the rigorous and continuously changing pressure, humidity, and temperature environment experienced by commercial aircraft, as well as the different cost, maintenance and weight constraints associated therewith.

Testing has shown that under high use commercial aircraft operating conditions certain lightning protective structures tend to experience substrate microcracking and finish cracking making them more susceptible to corrosion and ultraviolet degradation. Microcracking is sometimes referred to as “weave telegraphing”. Weave telegraphing refers to when: (a) the visual irregularities in the finishes take on the appearance of the underlying weave pattern of the surface, (b) the pattern becomes more pronounced while in-service, and (c) there is formation and propagation of substrate and/or paint finish cracking. Such microcracks tend to form due to repeated and extreme temperature, humidity, and pressure fluctuations. Microcracking occurs due to a number of factors including internal stresses from differences in coefficient of thermal expansion, as well as from non-optimum interface adhesion between components in composite systems. The microcracks can extend into visual paint layers, which can result in appearance degradation and increased maintenance and inspection times and costs

One type of lightning protective structure includes a substrate layer and interwoven wire fabric that has thin wires of metal running parallel to the carbon fabric tows. This system has been shown to be highly susceptible to corrosion and microcracking when used in the aggressive cyclical environment of high use jet aircraft.

Another type of lightning protective structure includes a substrate layer, a metal mesh screen and a non-structural outer film that may use a carrier or reinforcement material, such as glass or polyester. The mesh can be a metal woven fabric, random mat, or perforated metal that is usually expanded. Depending on the metal and substrate an additional prepreg layer, such as 9 mil thick glass/epoxy may be used for galvanic isolation to avoid corrosion between the base substrate and the metal mesh. This isolator typically weighs more than the surfacer. Traditionally the weight of the surfacer, including the resin needed to encapsulate the mesh to prevent corrosion and provide a smooth surface, exceeds the weight of the metal mesh. Historically, mesh systems have been heavy, more labor intensive than interwoven wire fabric and can be susceptible to microcracking.

Another protective structure approach is to use a solid metal over composite material. This structure is also heavy and difficult to process without manufacturing defects, such as voids, when co-cured as a solid film or applied as a spray to the cured part. Spray processes such as aluminum flame spray have the added complication of requiring qualified personnel and equipment typically not available at airline facilities.

Examples of known methods and systems for lightening protection of aircraft are set forth in U.S. Pat. Nos. 5,225,265, 5,370,921, 6,086,975, 6,303,206 and 6,435,507, the disclosures of which are incorporated herein by this reference thereto.

However, these known patents do not solve all of the above-mentioned problems and there still exists a need in the art for an improved method to form and a lightning protective structure for an aircraft that does not exhibit the above-mentioned disadvantages and which provides the corrosion resistance, prevention of substrate microcracking, rain erosion resistance, environmental durability, structural performance, and electromagnetic protection, including lightning protection characteristics desired, while at the same time being lighter in weight and less costly to maintain and repair.

### SUMMARY OF THE INVENTION

One embodiment of the present invention provides a method of forming an exterior surface protective system for an aircraft by uniting a surfacer, an expanded foil or woven metal fabric and an isolator. The surfacer comprises a SurfaceMaster 905 or a Hexcel M50 with polyester carrier or similar material with carbon or glass carrier that has resin flow characteristics that create a smooth surface for painting. The expanded aluminum foil is an improved lightweight version and is sandwiched between the surfacer and a lighter weight glass/epoxy isolator. The system may be placed over a composite layer or honeycomb substrate.

The above-stated embodiment provides increased structural durability, as well as electromagnetic protection while being lower in weight and providing minimum or reduced microcracking.

The embodiments of the present invention provide several advantages. One such advantage is the provision of a surface suitable for priming and painting; improved rain erosion resistance; improved corrosion resistance; the avoidance of microcracking and the provision of lightening protection with minimal impact to weight and lay-up labor. Lay-up labor is also reduced when using the option of combining the materials into one or more products prior to part fabrication. When the surfacer and foil are combined into one product using vacuum compaction, or nipping fabrication, costs are reduced. When a continuous version of expanded foil is pre-combined with the surfacer and/or isolator automated cutting can be used, thus further reducing costs by reducing scrap rate.

Another advantage provided by an embodiment of the present invention, is the provision of a surfacer having a tough epoxy structural substrate resin, which cooperates with the resin in a glass/epoxy isolator to fill in the metal holes in the expanded aluminum foil to provide the surface for priming and painting and the necessary environmental resistance. The other surfacer option is an inorganic filler surfacer that also commingles during cure with the isolator resin to fill the metal holes so as to also provide a surface for priming and painting and the necessary environmental resistance.

The expanded aluminum foil has its surface treated to protect it from corrosion and promote adhesion to the resins. This combination of materials is far less susceptible to microcracking, with the overall protection depending on the weight and thickness of the individual components in the system, but providing improved and unexpectedly better protection than known systems for the operating environment of high use commercial aircraft.

The present invention itself, together with further objects and attendant advantages, will be best understood by reference to the following detailed description, taken in conjunction with the accompanying drawings.

Other features, benefits and advantages of the present invention will become apparent from the following description of the invention, when viewed in accordance with the attached drawings and appended claims.

### BRIEF DESCRIPTION OF THE DRAWINGS

For a more complete understanding of this invention, reference should now be made to embodiments illustrated in greater detail in the accompanying figures and described below by way of examples of the invention wherein:

FIG. 1 is a perspective view of an aircraft incorporating a sample exterior fabric protective system in accordance with an embodiment of the present invention; and

FIG. 2 is a cross-sectional view of a sample exterior fabric protective system of FIG. 1.

### DETAILED DESCRIPTION

It has been determined through testing that under high use aircraft operating conditions that lightning protective structures containing carbon fiber with metal wires and/or expanded foil, which is disposed within an epoxy resin, tend to experience substrate microcracking and finish cracking. The present invention overcomes this and is described in detail below. While the present invention is described primarily with respect to the formation of an exterior protective structure for an aircraft, the present invention may be applied and adapted to various applications. The present invention may be applied in aeronautical applications, power applications, nautical applications, railway applications, automotive vehicle applications, medical applications, and commercial and residential applications where the need for a durable corrosive resistant and lightning protective structure that exhibits minimal or no weave telegraphing is desired and particularly when weight or labor costs are of a concern. Also, a variety of other embodiments are contemplated having different combinations of the below described features of the present invention, having features other than those described herein, or even lacking one or more of those features. As such, it is understood that the invention can be carried out in various other suitable modes.

In the following description, various operating parameters and components are described for one constructed embodiment. These specific parameters and components are included as examples and are not meant to be limiting.

Also, in the following description the term “component” refers to an artifact that is one of the individual parts of which a composite entity is made up. A component may refer to a part that can be separated from or attached to a system, a part of a system or assembly, or other part known in the art.

In addition, the term “surface” refers to the outer boundary of an artifact or a material layer constituting or resembling such a boundary. A surface may include not only the outer edge of a material, but also an outermost portion or layer of a material. A surface may have a thickness and include various particles.

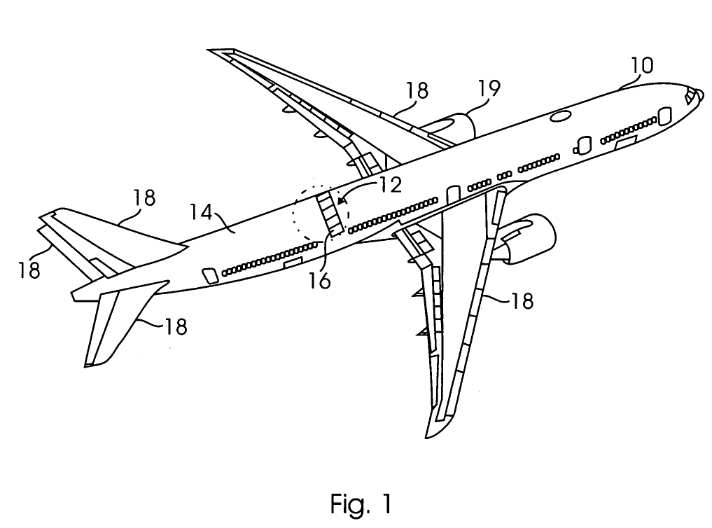

FIG. 1 shows a perspective view of an aircraft 10 incorporating a sample exterior fabric protective system 12 in accordance with an embodiment of the present invention. The protective system 12 extends across selected portions of the exterior 14 of the aircraft 10. The protective system 12 is applied over an aircraft part(s), such as the fuselage 16, nacelle 19 and tail or wings 18, of the aircraft 10 to protect against lightning and to endure other environmental conditions. The protective system 12 includes multiple layers, which are described in detail below.

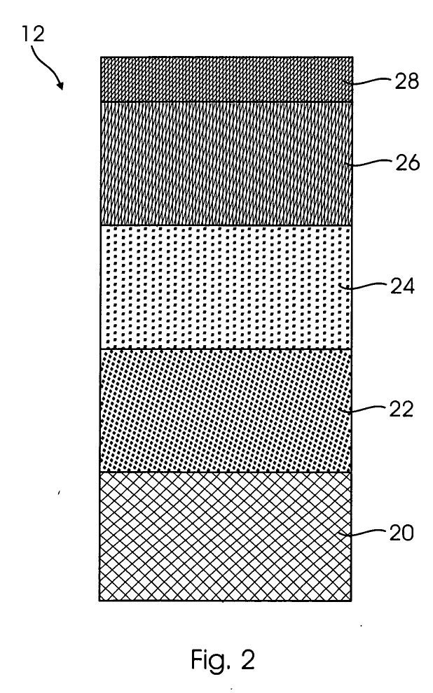

Referring now to FIG. 2, a cross-sectional view of the protective system 12 in accordance with an embodiment of the present invention is shown. The protective system 12 is applied to a base substrate 20 on all, or any desired portion, such as the nacelle 19. An isolator 22 is disposed over and coupled to the base substrate 20. A metal layer, such as an expanded aluminum foil 24 is disposed over and is coupled to the isolator 22. A surfacer 26 is applied to the metal layer 24 and, after cure, any required finishes such as spray applied surfacers, pin hole fillers, primers, and paint topcoats 28, are applied to the surfacer 26. Although a single paint layer 28, a single surfacer layer 26, a single isolator layer 22 and a single substrate layer 20 are shown, any number of each may be used. The lay-up order can be surfacer, metal layer, isolator, substrate or the reverse i.e. substrate, isolator, metal layer, surfacer depending on the tooling concept for the specific application. Finally, the base substrate 20 may be a composite structure or a honeycomb structure.

For autoclave purposes the product forms are as described herein. A similar approach can be adapted for resin infusion processes but then the surfacer and isolator reinforcements need to be provided dry and then resin added at the time of fabrication.

Examples of surfacers that may be used are various grades of Cytec SurfaceMaster 905, such as a nominal weight of 0.0325 lbs/sq. ft. from Cytec Engineered Materials Inc. of Anaheim, Calif., Hexcel polyester carrier, such as BBA polymat with Hexcel M50 tough epoxy resin having a polyester carrier, and Hexcel 106 E-glass with Hexcel M50 epoxy resin, from Hexcel Corporation of Dublin, Calif. that can be 0.01 lbs/sq. ft. or more. Examples of isolators include Hexcel S-2 glass/epoxies 6012/M50, 6012/F161, 6013/M50, 6013/F161, 6080/M50, 6080/F161, 4180/M50 and 4180/F161 or other S-2 glass weaves with organic resins such as epoxy, cyanate ester, polyimides or thermoplastics. A top coat of about 2 mils of enamel is applied to the system over various thicknesses of a primer and an intermediate coat to aid paint removal. Other primer/top coat combinations are also viable.

A feature of this system is that it not only performs with typical production paint thickness, such as 2 mil topcoats, but also provides more protection at the maximum aircraft threat levels compared to the composite system IWWF even when paint is as much as ten times thicker.

The invention preferably uses isolators that have low weights of from about 0.014 psf to about 0.0154 psf with resin content varying from about 28% to about 49%.

Using surfacers with weights ranging from 0.01 psf to 0.0325 psf and isolator plys with weights of from 0.014 psf to 0.037 psf provide lighter components than the traditionally used surfacers having a weight of 0.05 psf and a galvanic ply of 0.091 psf. Even further weight savings is possible for the system when using lighter expanded foil of from 0.008 psf to 0.013 instead of the normally used 0.016 psf aluminum version or 0.040 psf copper version.

Examples of the preferred thicknesses of various matrixes utilizing the surfacers, expanded aluminum foil (EAF) and isolators described above and having an enamel, intermediate primer, if desired for ease of paint removal and primer layers thereon, are set forth below:

### EXAMPLE 1

enamel 2 mils, intermediate coat 0.3-0.5 mil, primer 0.5 mil, Hexcel BBA Polymat/M50 surfacing film, Alcore 2 mil EAF, Hexcel 6080/M50 isolator (1 ply);

### EXAMPLE 2

enamel 2 mils, intermediate coat 0.3-0.5 mil, primer 0.5 mil, Hexcel BBA Polymat/M50 surfacing film, EAF 4 mil, Hexcel 6080/M50 isolator (1 ply);

### EXAMPLE 3

enamel 2 mils, intermediate coat 0.3-0.5 mil, primer 0.5 mil, Hexcel BBA Polymat/M50+30 gsm additional resin surfacing film, Alcore 4 mil EAF, Hexcel 6080/M50 isolator (1 ply);

### EXAMPLE 4

enamel 2 mils, intermediate coat 0.3-0.5 mil, primer 0.5 mil, Hexcel BBA Polymat/M50+58 gsm additional resin surfacing film, Alcore 2 mil EAF, Hexcel 6080/F161 isolator (1 ply);

### EXAMPLE 5

enamel 2 mils, intermediate coat 03-0.5 mil, primer 0.5 ml, Hexcel BBA Polymat/M50+58 gsm additional resin surfacing film, Alcore 4 mil EAF, Hexcel 6080/F161 isolator (1 ply);

### EXAMPLE 6

enamel 2 mils, intermediate coat 0.3-0.5 mil, primer 0.5 mil, Cytec SurfaceMaster 905 Grade 2 surfacing film, Alcore 4 mil EAF, Hexcel 6080/M50 isolator (1 ply);

### EXAMPLE 7

enamel 2 mils, intermediate coat 0.3-0.5 mil, primer 0.5 mil, Hexcel 106 Glass/M50 surfacing film, Hexcel 2 mil (0.013 psf) EAF, Hexcel 6081/F161 isolator (1 ply);

### EXAMPLE 8

enamel 2 mils, intermediate coat 0.3-0.5 mil, primer 0.5 mil, Hexcel 106 Glass/M50 surfacing film, Hexcel 2 mil (0.013 psf) EAF, Hexcel 4180/F161 isolator (1 ply);

### EXAMPLE 9

enamel 2 mils, intermediate coat 0.3-0.5 mil, primer 0.5 mil, Hexcel 106 Glass/M50 surfacing film, Hexcel 2 mil (0.013 psf) EAF, Hexcel 4180/F161 isolator (1 ply);

The metal mesh layer or ply 24 is preferably an expanded aluminum foil (EAF), but could be formed of any other expanded metal, such as phosphor bronze, nickel coated copper, copper, stainless steel, or other conductive materials having similar electrical and thermal characteristics or a combination thereof. These other metals would also use an isolator even if it is not required for galvanic compatibility in order to provide maximum microcracking resistance.

The commingled technique described herein along with the use of a lightweight expanded aluminum and resin filed isolators that fill the openings in the expanded aluminum provides a protective structure that satisfies lightning protection requirements. The thickness of the EAF is adjusted depending upon the surfacer and isolator used, the amount of lightning protection and the amount of other environmental protection desired.

The protective system 12 is durable and can withstand environmental cycling associated with a commercial aircraft including those such as high use large commercial aircraft. Prior to approval for commercial use exterior portions of an aircraft undergo rigorous testing to simulate commercial use. Some of this testing includes subjecting a component to simulated lightening testing. The testing may include subjecting the specimen to zone 1A 200 kA peak current and Zone 2A 100 kA currents to assess safety as well as lower lightening currents such as 10 kA to assess repair costs for more likely threats.

The present invention provides a cost effective and efficient system and method for the formation of lightweight lightning protective systems. The present invention is lightweight, simplistic in design, prevents corrosion, and is durable. It can be as much as 75% lighter per square area installed than traditional metal layer lightening protection systems. As such, the present invention increases service life and reduces maintenance costs of an aircraft and associated exterior components.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A method of forming an exterior surface protective structure for an aircraft comprising:
providing a surfacer having a resin carrier;
a metal mesh substrate having a plurality of holes;
an isolator having resin and glass fabric; and
combining said surfacer, said metal mesh substrate and said isolator so that the resin in said surfacer and said isolator fill in the plurality of holes in the metal mesh to provide a surface for priming and painting the exterior surface protective structure.

2. The method of claim 1 wherein said metal mesh comprises an expanded aluminum foil.

3. The method of claim 2 wherein said expanded aluminum foil is between 1.5 and 4 mils thick.

4. The method of claim 3 wherein said expanded aluminum foil is about 2 mils thick.

5. The method of claim 2 wherein said expanded aluminum foil is provided in sheet or continuous roll form.

6. The method of claim 1 wherein the surfacer, metal mesh and isolator may be applied as three separate products or various combinations of pre-combined products.

7. The method of claim 1 wherein said surfacer comprises Cytec SurfaceMaster 905.

8. The method of claim 1 wherein said surfacer comprises a Hexcel polyester carrier, such as BBA polymat with Hexcel M50 tough epoxy resin having a polyester carrier.

9. The method of claim 1 wherein said surfacer comprises Hexcel 106 E-glass with Hexcel M50 epoxy resin.

10. The method of claim 1 wherein said isolator comprises Hexcel 6012/M50.

11. The method of claim 1 wherein said isolator comprises Hexcel 6012/F161.

12. The method of claim 1 wherein said isolator comprises Hexcel 6013/M50.

13. The method of claim 1 wherein said isolator comprises Hexcel 6013/F161.

14. The method of claim 1 wherein said isolator comprises Hexcel, 6080/M50.

15. The method of claim 1 wherein said isolator comprises Hexcel, 6080/F161.

16. The method of claim 1 wherein said isolator comprises Hexcel 4180/M50.

17. The method of claim 1 wherein said isolator comprises Hexcel 4180/F161.

18. A protective fabric system for an exterior of an aircraft comprising:
a surfacer having a resin and carrier;
a metal mesh substrate having a plurality of holes; and
an isolator having a resin and carrier;
wherein said surfacer, said metal mesh substrate and said isolator are combined so that the resin carrier in said surfacer and said isolator fill in the plurality of holes in the metal mesh to provide a surface for priming and painting the exterior surface.

19. The protective fabric system of claim 18 wherein said metal mesh comprises an expanded aluminum foil.

20. The protective fabric system of claim 19 wherein said expanded aluminum foil is between 1.5 and 4 mils thick

21. The protective fabric system of claim 18 wherein said surfacer is selected from Cytec SurfaceMaster 905, Hexcel polyester carrier, such as BBA Hexcel BBA polymat with Hexcel M50 tough epoxy resin having a polyester carrier and Hexcel 106 E-glass with Hexcel M50 epoxy resin.

22. The protective fabric system of claim 18 wherein said isolator is selected from Hexcel 6012/M50, Hexcel 6012/F161, Hexcel 6013/M50, Hexcel 6013/F161, Hexcel 6080/M50, Hexcel 6080/F161, Hexcel 4180/M50 and Hexcel 4180/F161 or other S-2 glass weaves with organic resins such as epoxy, cyanate ester, polyimides or thermoplastics.
